(19) United States
(12) Patent Application Publication
(10) Pub. No.: US 2003/0127907 A1
(43) Pub. Date: Jul. 10, 2003

(54) Bicycle wheel to be installed on a wheel axle that is mounted with a freewheel

(76) Inventor: Chao-Ying Chen, Tainan Hsien (TW)

Correspondence Address: WHYTE HIRSCHBOECK DUDEK S C, 111 EAST WISCONSIN AVENUE, SUITE 2100, MILWAUKEE, WI, 53202

(21) Appl. No.: 10/037,949

(22) Filed: Jan. 4, 2002

(51) Int. Cl. B60B 1/02

(52) U.S. Cl. 301/55

(57) ABSTRACT

A bicycle wheel includes a hub mounted on a wheel axle, a wheel rim, and first and second spokes. The hub has a first end portion proximate to a freewheel mounted on the wheel axle, and an opposite second end portion. The first spokes connect the first end portion of the hub to the wheel rim. The second spokes connect the second end portion of the hub to the wheel rim. The wheel rim is formed with a plurality of spoke mounting hole sets, each of which includes a first number of first holes and a second number of second holes. The first spokes are mounted respectively on the first holes. The second spokes are mounted respectively on the second holes. The first number is greater than the second number, and the sum of the first and second numbers is an odd number not less than five.

### BACKGROUND OF THE INVENTION

1. Field of the Invention

The present invention relates to a bicycle wheel to be installed on a wheel axle that is mounted with a freewheel, more particularly to a bicycle wheel having different numbers of left and right spokes in order to prevent breaking of the spokes that are disposed proximate to the freewheel.

2. Description of the Related Art

Referring to FIGS. 1 and 2, a bicycle having a speed changing function is shown to include a rear bicycle wheel 1 mounted rotatably on a wheel axle 100 which has two opposite ends carried by left and right prongs 16, 17 of a bicycle rear fork and which further has a freewheel 15, i.e. a speed changing gear mechanism, mounted thereon, typically on a right side of the wheel 1. The wheel 1 has a wheel rim 11, a hub 12 sleeved rotatably on the wheel axle 100, and a plurality of left and right spokes 14, 14′ for connecting left and right end portions 122, 123 of the hub 12 to the wheel rim 11. The wheel rim 11 has annular left and right tire retaining walls 111, 112 and an annular spoke mounting wall 113 which interconnects radial inner edges of the tire retaining walls 111, 112 and which is formed with a plurality of angularly displaced spoke mounting holes 114 for mounting the left and right spokes 14, 14′. The left and right spokes 14, 14′ are arranged alternately around the hub 12. It is found that, due to the presence of the freewheel 15, which is mounted on the wheel axle 100 at a right side of the bicycle wheel 1, the stress applied on each of the right spokes 14′ would be greater than that applied on each of the left spokes 14. Therefore, the right spokes 14′ easily break after a period of use. To solve this problem, it has been proposed heretofore to increase the number of the left and right spokes 14, 14′ to reduce the stress applied to each of the left and right spokes 14, 14′. This, however, is not desirable in view of the recent trend toward lightweight bicycles.

### SUMMARY OF THE INVENTION

Therefore, the main object of the present invention is to provide a bicycle wheel which can prevent breaking of spokes that are disposed proximate to a freewheel on a wheel axle.

Accordingly, the bicycle wheel of the present invention is adapted to be installed on a wheel axle having a freewheel mounted thereon such that the freewheel is disposed on one side of the bicycle wheel. The bicycle wheel includes a hub, an annular wheel rim, a plurality of first spokes, and a plurality of second spokes. The hub is adapted to be mounted rotatably on the wheel axle adjacent to the freewheel. The hub has a first end portion proximate to the freewheel, and a second end portion opposite to the first end portion along the length of the wheel axle. The wheel rim is disposed around the hub and has a central axis. The wheel rim includes spaced-apart left and right tire retaining walls, and an annular spoke mounting wall interconnecting the tire retaining walls. The first spokes connect the first end portion of the hub to the wheel rim. The second spokes connect the second end portion of the hub to the wheel rim. The spoke mounting wall is formed with a plurality of spoke mounting hole sets, each of which includes a first number of first holes and a second number of second holes. The first spokes are mounted respectively on the first holes of the spoke mounting hole sets. The second spokes are mounted respectively on the second holes of the spoke mounting hole sets. The first number is greater than the second number, and the sum of said first and second numbers is an odd number not less than five.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a conventional bicycle wheel when mounted on a wheel axle that has a freewheel mounted thereon;

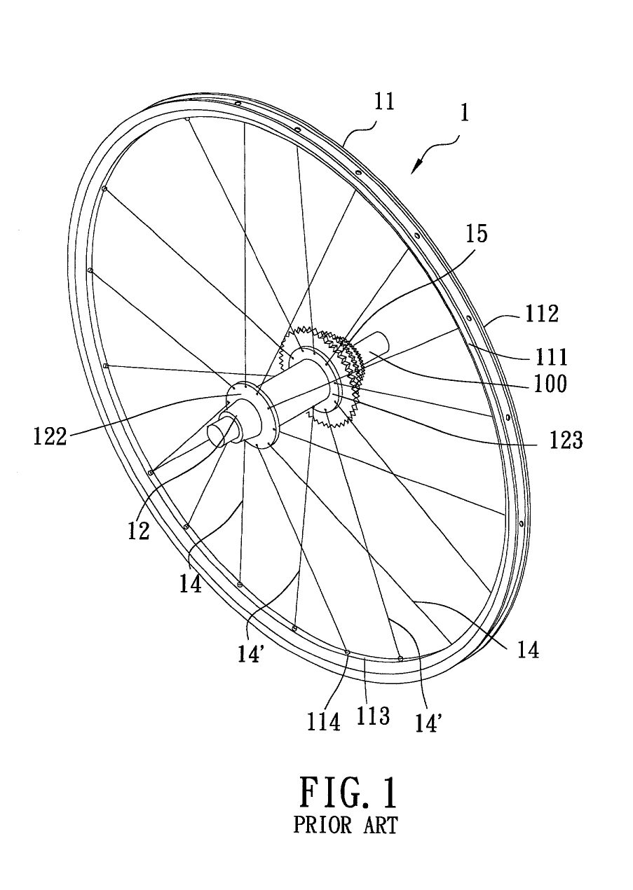

FIG. 2 is a fragmentary partly-sectioned view of the bicycle wheel of FIG. 1, where two opposite ends of the wheel axle are shown to be carried by two prongs of a bicycle fork;

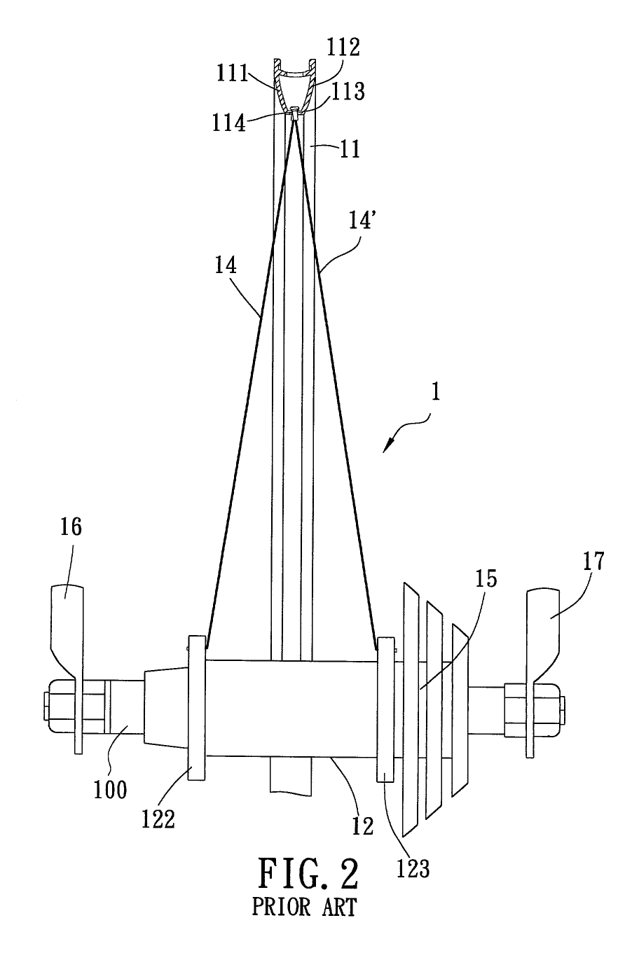

FIG. 3 is a perspective view of a preferred embodiment of a bicycle wheel of the present invention;

FIG. 4 is a fragmentary partly-sectioned view of the bicycle wheel of FIG. 3, where two opposite ends of the wheel axle are shown to be carried by two prongs of a bicycle fork; and

FIG. 5 is a fragmentary top view of FIG. 4.

### DETAILED DESCRIPTION OF THE PREFERRED EMBODIMENT

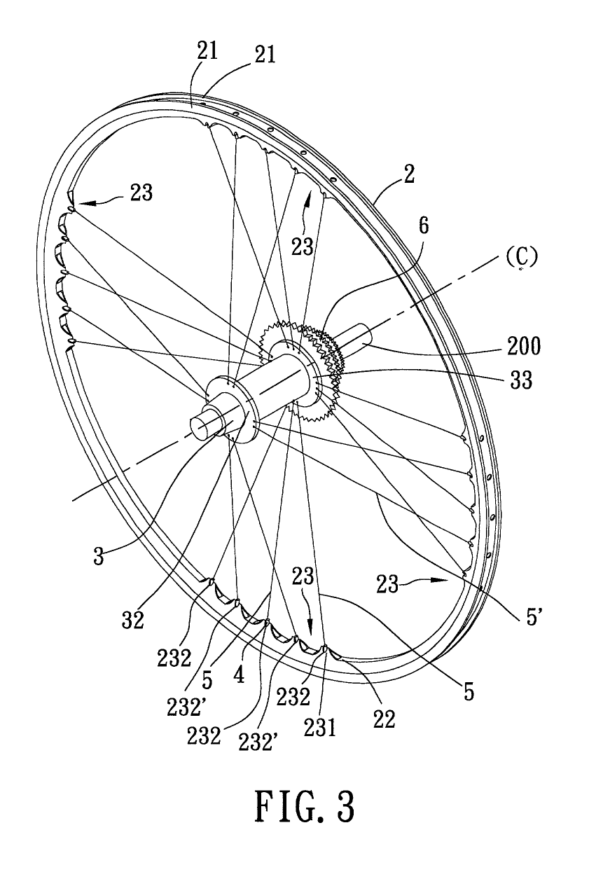

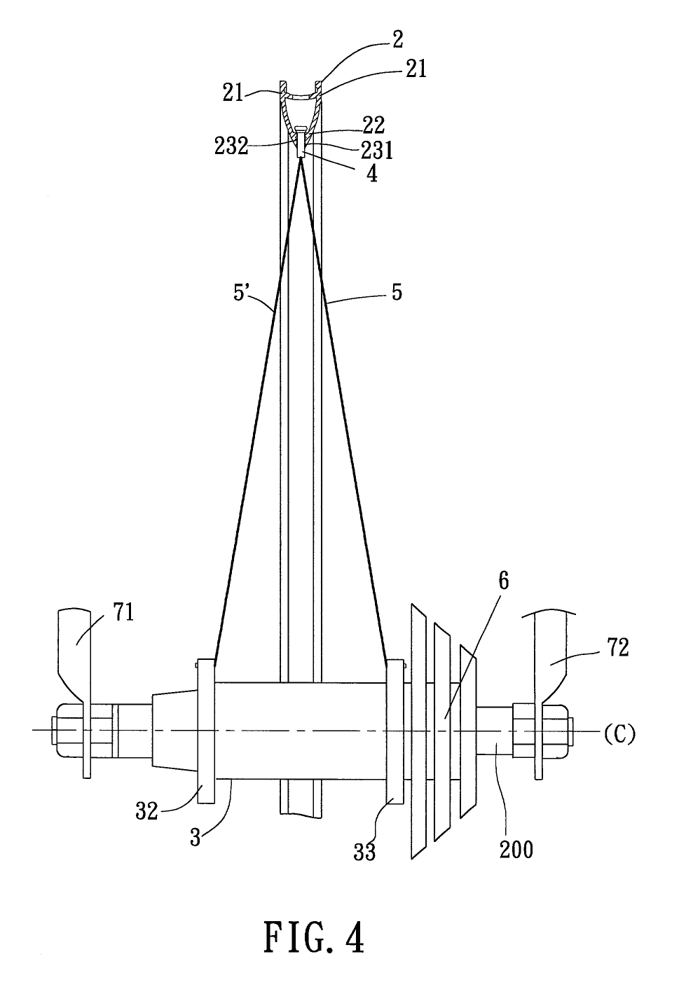

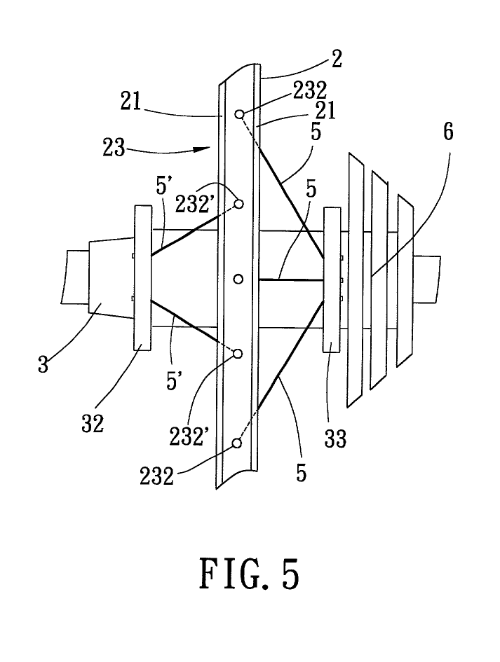

Referring to FIGS. 3, 4 and 5, the bicycle wheel of the present invention is adapted to be mounted on a wheel axle 200 which has a freewheel 6, i.e., a speed changing gear mechanism, mounted thereon and disposed on a right side of the bicycle wheel. The wheel axle 200 has two opposite ends carried respectively by two prongs 71, 72 of a bicycle fork. The bicycle wheel includes a hub 3 adapted to be sleeved rotatably on the wheel axle 200, an annular wheel rim 2 disposed around the hub 3 and having a central axis (c) extending substantially along the wheel axle 200, a plurality of first spokes 5, and a plurality of second spokes 5′. The hub 3 has a first end portion formed with a first annular flange 33 and disposed proximate to the freewheel 6, and a second end portion opposite to the first end portion along the central axis (C) and formed with a second annular flange 32. The first spokes 5 interconnect the wheel rim 2 with the first annular flange 33, whereas the second spokes 5′ interconnect the wheel rim 2 with the second annular flange 32.

The wheel rim 2 includes spaced-apart annular left and right tire retaining walls 21 with inner ends proximate to the central axis (C), and outer ends distal from the central axis (C), and an annular spoke mounting wall 22 extending between and interconnecting the inner ends of the tire retaining walls 21. The spoke mounting wall 22 has four spoke mounting portions 23 which are displaced angularly from one another. Each of the spoke mounting portions 23 is formed with a plurality of angularly displaced mounting projections 231 which project radially and inwardly from the spoke mounting wall 22 toward the central axis (C). Each of the mounting projections 231 is formed with a spoke mounting hole 232, 232′ that extends radially through the spoke mounting wall 22. Preferably, the number of the mounting projections 231 in each of the spoke mounting portions 23 is an odd number, more preferably, an odd number not less than five. In the present embodiment, five mounting projections 231 are formed in each of the spoke mounting portions 23.

The spoke mounting holes 232, 232′ in each of the spoke mounting portions 23 constitute a spoke mounting hole set. The spoke mounting wall 22 is thus formed with a plurality of spoke mounting hole sets respectively in the spoke mounting portions 23. In this embodiment, each of the spoke mounting hole sets includes three first holes 232 which are formed in the first, third, and fifth ones, i.e. the odd-numbered ones, of the mounting projections 231 of a respective spoke mounting portion 23, and two second holes 232′ which are formed in the second and fourth ones, i.e. the even-numbered ones, of the mounting projections 231 of the respective spoke mounting portion 23. The first holes 232 are arranged alternately with the second holes 232′.

Each of the first spokes 5 has one end mounted on a respective one of the first holes 232 in the spoke mounting portions 23 by means of a respective spoke fastener 4, and another end mounted on the first annular flange 33 of the hub 3 for interconnecting the first end portion of the hub 3 with the wheel rim 2. Each of the second spokes 5′ has one end mounted on a respective one of the second holes 232′ in the spoke mounting portions 23 by means of a respective spoke fastener 4, and another end mounted on the second annular flange 32 of the hub 3 for interconnecting the second end portion of the hub 3 with the wheel rim 2. As a consequence, the first and second spokes 5, 5′ are arranged alternately along each of the spoke mounting portions 23. Each of the spoke mounting portions 23 is thus connected to the first annular flange 33 of the hub 3 via three first spokes 5, and is connected to the second annular flange 32 of the hub 3 via two second spokes 5′. The number of the first spokes 5 is greater than the number of the second spokes 5′. The ratio of the first spokes 5 to the second spokes 5′ is equal to the ratio of the number of the first holes 232 to the number of the second holes 232′, and is 3/2 in this embodiment.

Accordingly, it is proposed in the present invention to increase only the number of the spokes 5 which are connected to the first end portion of the hub 3 that is proximate to the freewheel 6. The weight of the bicycle wheel and the total number of the spokes 5, 5′ are not significantly increased, while the stress applied by the freewheel 6 to each of the first spokes 5 can be reduced to prevent breaking of the first spokes 5 due to the load of the freewheel 6.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A bicycle wheel adapted to be installed on a wheel axle having a freewheel mounted thereon such that the freewheel is disposed on one side of the bicycle wheel, said bicycle wheel comprising:
a hub adapted to be mounted rotatably on the wheel axle adjacent to the freewheel, said hub having a first end portion proximate to the freewheel, and a second end portion opposite to said first end portion along the length of the wheel axle;
an annular wheel rim disposed around the hub and having a central axis, said wheel rim including spaced-apart left and right tire retaining walls, and an annular spoke mounting wall interconnecting said tire retaining walls;
a plurality of first spokes for connecting said first end portion of said hub to said wheel rim; and
a plurality of second spokes for connecting said second end portion of said hub to said wheel rim;
wherein said spoke mounting wall is formed with a plurality of spoke mounting hole sets, each of which includes a first number of first holes and a second number of second holes, said first spokes being mounted respectively on said first holes of said spoke mounting hole sets, said second spokes being mounted respectively on said second holes of said spoke mounting hole sets, said first number being greater than said second number, the sum of said first and second numbers being an odd number not less than five.

2. The bicycle wheel as claimed in claim 1, wherein said first holes and said second holes of each of said spoke mounting hole sets are angularly displaced from one another and are arranged alternately with each other.

3. The bicycle wheel as claimed in claim 1, wherein the ratio of said first number to said second number is 3/2.

4. The bicycle wheel as claimed in claim 1, wherein said spoke mounting wall includes a plurality of spoke mounting portions which are angularly arranged along said spoke mounting wall, each of said spoke mounting portions being formed with a respective one of said spoke mounting hole sets.

5. The bicycle wheel as claimed in claim 4, wherein each of said spoke mounting portions includes a plurality of mounting projections which project radially and inwardly from said spoke mounting wall, each of said mounting projections being formed with a respective one of said first and second holes, each of said first and second holes extending radially and respectively through a corresponding one of said mounting projections.
